(19) United States
(12) Patent Application Publication
(10) Pub. No.: US 2009/0167554 A1
(43) Pub. Date: Jul. 2, 2009

(54) APPARATUS AND METHODS SUITABLE FOR LOCATION RELATED INFORMATION REPORTING

(75) Inventors: Arun Munje, Ottawa (CA); Shailesh Kaul, Ottawa (CA)

Correspondence Address: STIKEMAN ELLIOTT LLP, 1600-50 O''CONNOR STREET, OTTAWA, ON, KIP 6L2, CA

(73) Assignee: Integrating Technology Over The Air (iTechOTA)

(21) Appl. No.: 12/048,386

(22) Filed: Mar. 14, 2008

Related U.S. Application Data
(60) Provisional application No. 60/906,836, filed on Mar. 14, 2007.

(51) Int. Cl. G08B 5/22

(52) U.S. Cl. 340/825.49

(57) ABSTRACT

A method suitable for location reporting, comprising the step of reporting location information periodically based on a distance period.

### CROSS-REFERENCE TO RELATED APPLICATIONS

This application claims priority from U.S. Provisional Application No. 60/906,836 filed Mar. 14, 2007.

### MICROFICHE APPENDIX

Not applicable.

### TECHNICAL FIELD

This application relates to tracking of mobile assets in general, and to an apparatus and methods suitable for location related information reporting, in particular.

### BACKGROUND OF THE APPLICATION

Tracking of mobile assets is becoming an important feature. With the advancements and availability of positioning systems (like GPS systems) and also the data connection availability on mobile devices (some of which also have GPS receivers built in to them), systems can be put in place to periodically report locations from the mobile device to a server. However since data bandwidth is used for reporting, simple periodic reporting maybe to frequent in some scenarios and to infrequent in other cases.

Consequently, there is a need for an apparatus and methods suitable for location related information reporting, some embodiments of which at least enable the selection of appropriate data points to report, thereby optimizing both mobile device battery life and also bandwidth used.

### SUMMARY

Aspects and features of the present application will become apparent to those ordinarily skilled in the art upon review of the following description of specific embodiments of an apparatus and methods suitable for location related information reporting in conjunction with the accompanying drawing figures.

### BRIEF DESCRIPTION OF THE DRAWINGS

Embodiments of the present application will now be described, by way of example only, with reference to the accompanying drawing figures, wherein:

FIG. 1 shows an embodiment of a system provided in accordance with the techniques of the present application;

FIG. 2 depicts a first aspect of the present technique using an example path along which an asset is moving;

FIG. 3 depicts a second aspect of the present technique using an example path on which an asset is moving;

FIG. 4 depicts a third aspect of the present technique using an example path on which an asset is moving;

FIG. 5 depicts a fourth aspect of the technique using an example path on which an asset moves;

FIG. 6 depicts a fifth aspect of the technique using an example path on which an asset moves;

FIG. 7 depicts a sixth aspect of the technique using an example path on which an asset moves;

FIG. 8 depicts a seventh aspect of the technique using an example path on which an asset moves;

FIG. 9 depicts an eighth aspect of the technique using an example path on which an asset moves; and

FIG. 10 depicts a ninth aspect of the technique using an example path on which an asset moves.

Like reference numerals are used in different figures to denote similar elements.

### DETAILED DESCRIPTION OF THE DRAWINGS

Location related information, or more briefly location information, as used in the present specification and in the appended claims means information which is derived from or related to location generally. Specific examples include but are not limited to at least one of: any information related to location, direction, path, NMEA structures or messages and the like, velocity, and speed; or any information related to a change of location, direction, path NMEA structures or messages and the like, velocity and speed.

Embodiments of an apparatus and methods suitable for location related information reporting include the following aspects of the technique, either practised on their own, or in combination.

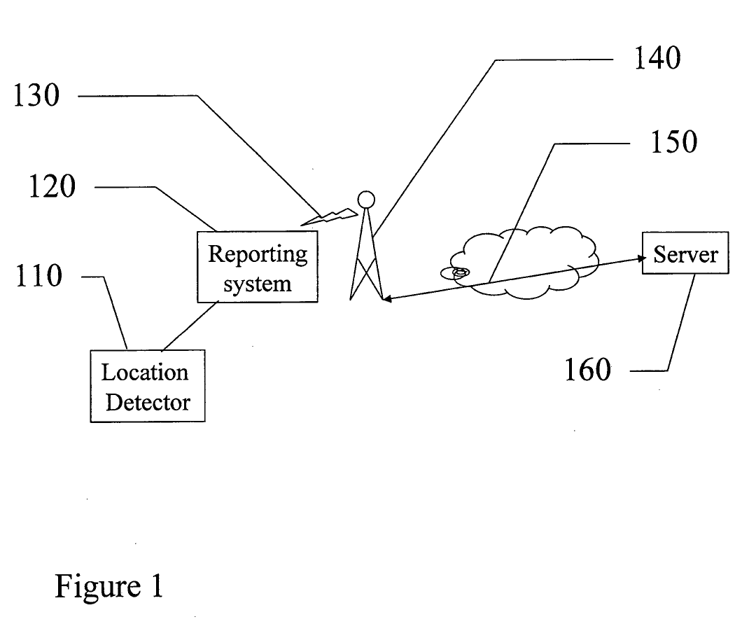

Referring to the drawings, FIG. 1 shows an embodiment of a system provided in accordance with the techniques of the present application. Several components are involved in collecting relevant data about the location of an asset and transmitting it to a server: Location Detector 110 detects the physical location of an asset; Reporting System 120 receives the location data from Location Detector 110 and has radio connectivity so as to be able to transmit wirelessly using Radio Channel 130 to Base Station 140. Base Station 140 in turn reports using a Network 150 to Sever 160. In a preferred embodiment, Location Detector 110 is a GPS (Global Positioning System) based Location Detector. In alternate embodiments, Location Detector 110 is a Location Detector based on the European Galileo technology, or the Wi-Fi Positioning System of Skyhook Wireless and the like, which are foreseeable alternatives to GPS technology. In a preferred embodiment, Network 150 is the Internet. Server 160 is a node connected to Network 150 which may have an interest in receiving reports about the location data from Reporting System 120.

In alternate embodiments, Location Detector 110 and Reporting System 120 may be on the same device, such as for example a wireless data communication device operating on a cellular network and having an integrated GPS receiver, or separate components such as a similar wireless data communication device communicating over BlueTooth® or ZigBee® with a GPS receiver. The entire system of FIG. 1 is used to collect location points at Location Detector 110, process the points in Reporting System 120, and reconstruct the points or the path in Server 160.

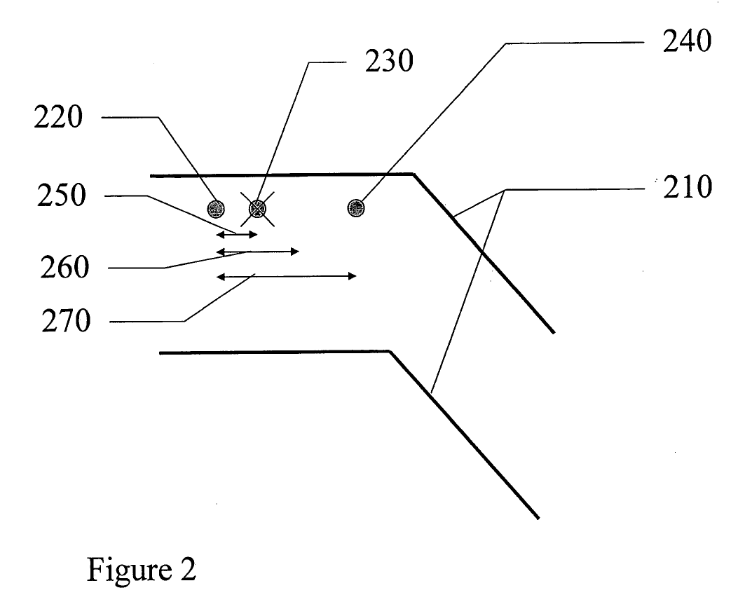

Referring to the next sheet of the drawings, FIG. 2 depicts a first aspect of the present technique using an example path along which an asset is moving. The asset (not shown) is moving along Path 210. At a first location point 220, a location report is made. At an intermediate location point 230, which is an intermediate distance 230 away from the first location point 220 that is not far enough away from first location point 220 to warrant a location report, advantageously the intermediate location point 230 is collected, but further advantageously no location information is reported. At a next location point 240 which is a second distance 270 away from the first location point 220, which is sufficiently far enough away from first location point 220 to warrant a location report, advantageously location information is reported. Generally, a minimum distance is required for any displacement from a first location point to an intermediate point to be worthy of a report, the intermediate point thereby becomes the next location point from which the location is reported, after which he process begins anew with the next location point taking on the role of the first location point.

As shown in FIG. 2, first distance 250 is less than the required minimum distance 260 so intermediate location point 230 is not reported. However, since the second distance 270 between the first location point 220 and the next location point 240 is greater than the required minimum distance 260, location information at the next location point 240 is reported.

Thus, according to the first aspect depicted, location information is reported periodically based on a distance period, wherein a new point has to be at least a distance period away from a previous point as a pre-condition to providing a location report. In one embodiment, an asset is assumed to be at the same location if the new point is not at least a distance period away from a previous point. In one embodiment, a new location report is not sent if the asset can be assumed to be at the same location. In alternate embodiments, the distance period is either a given pre-determined value, or a configurable value, the latter being the preferred mode envisaged for this aspect by the inventors. In one embodiment, a configurable timeout is also provided so as to ensure that reporting occurs no later than the timeout period, if location reporting is so configured for active location reporting.

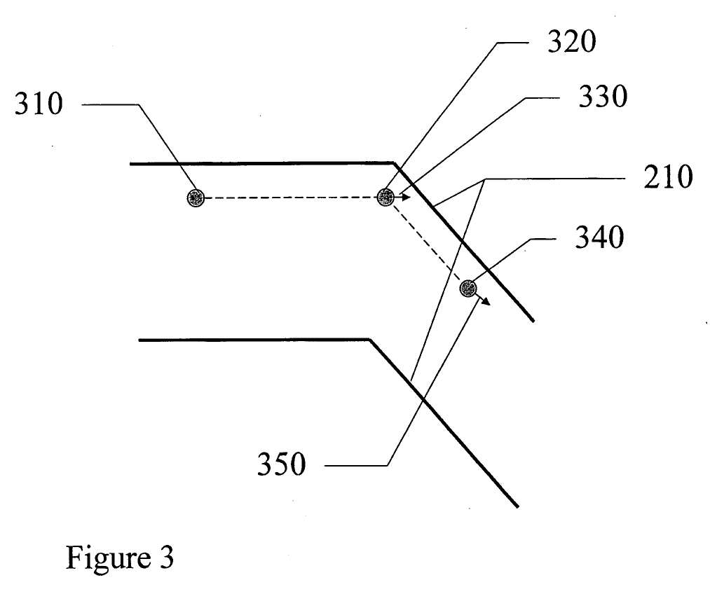

Referring to the third sheet of the drawings, FIG. 3 depicts a second aspect of the present technique using an example path on which an asset is moving. A first location point 310, a second location point 320 and a third location point 340 are location points that were received as information in one or more location reports by Server 120. A first direction 330 is illustrated along which an asset is assumed to be moving when at location point 320, and a second direction 350 is illustrated along which the asset is assumed to be moving when at location point 340.

As shown in FIG. 3, the first direction 330 is determined by relating the first location point 310 to the second location point 320. Similarly the second direction 350 is determined by relating the second location point 320 and a third location point 240.

Thus, according to the second aspect depicted, a direction for the moving asset can be determined from information in a location report. In alternative embodiments, the information used to determine the direction of the moving asset is obtained directly from the report, or indirectly by using the previous point. In one embodiment, if the location detector provides velocity information such as obtained by relating consecutive points, then the reporting system uses the location detector provided velocity information when reporting direction. In an alternate embodiment, the reporting system determines direction information by relating consecutive points.

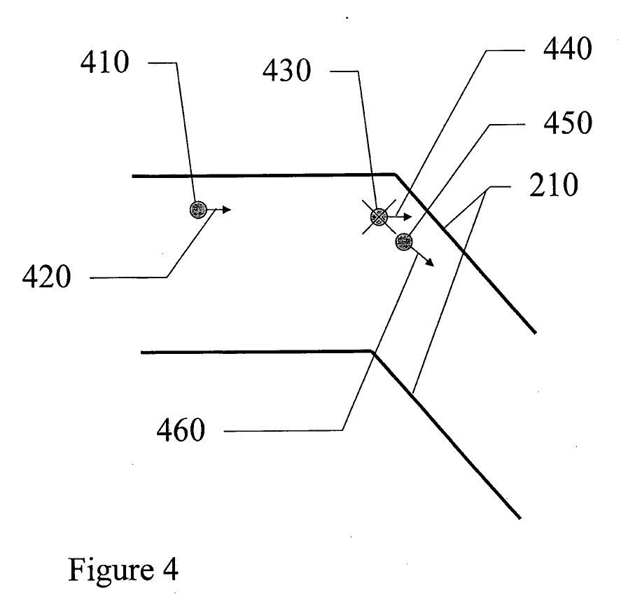

Referring to the fourth sheet of the drawings, FIG. 4 depicts a third aspect of the present technique using an example path on which an asset is moving. A first location point 410 is the location of a point where a location report is made, and a first direction 420 is the corresponding direction for the asset. When the asset is at an intermediate point location 430, location information is not reported while the intermediate direction 440 of the asset is not sufficiently different from the first direction 420. When the asset is at a next location point 450 at which location information is reported as the corresponding next direction 460 has changed sufficiently to be worthy of reporting.

As shown in FIG. 4, the intermediate direction 440 did not change much as the asset moved from location point 420 to location point 430, so at location point 430 no location information is reported. However, at next location point 450, next direction 460 changed significantly so at location point 450, location information is reported.

Thus, according to a third aspect, an optimization on reporting location is to report when there is a change in direction by at least a direction change threshold value. In alternative embodiments, the direction change threshold value is either a given pre-determined value, or a configurable value, the latter being the preferred mode envisaged for this aspect by the inventors. In one embodiment, a configurable timeout is also provided so as to ensure that reporting occurs no later than the timeout period, if location reporting is so configured for active direction reporting.

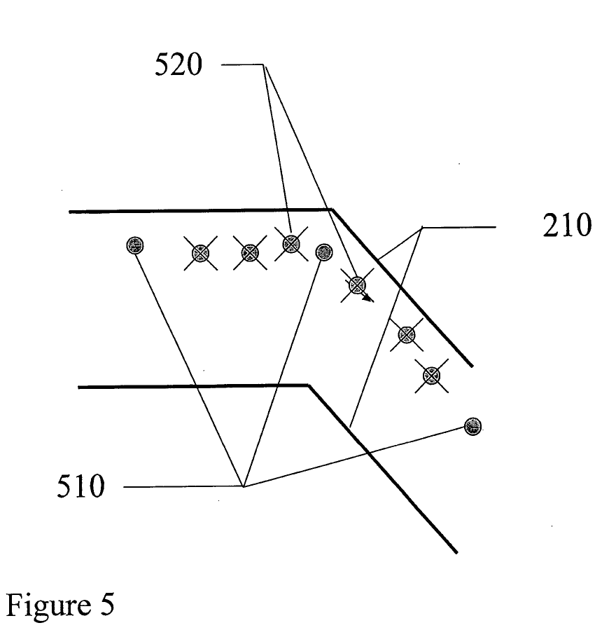

Referring to the fifth sheet of the drawings, FIG. 5 depicts a fourth aspect of the technique using an example path on which an asset moves. As depicted, some location points 510 are examples of points that are reported; and other location points 520 are examples of points that are not reported.

As shown in FIG. 5, many location points 210 are detected by Location Detector 110, but the Reporting System 120 determines after collecting these points that only the select location points 510 are sufficiently critical and discards the non-select other points.

Thus, according to a fourth aspect, an optimization can be done by recording many points traversed and periodically going through them to report on critical points selected from the many points. In one embodiment, the critical points can be determined by an optimum number of points that can be used to reconstruct the path within an error. In yet further alternative embodiments, the error is either a given pre-determined value, or a configurable value. The latter being the preferred mode envisaged for this aspect by the inventors. In one embodiment, the configurable error value is based on how timely the report needs to be. For example, in many cases small delays in reporting may be acceptable. In one embodiment, new critical points can be created by interpolating recorded points in order to have a better fit curve based on the reported points.

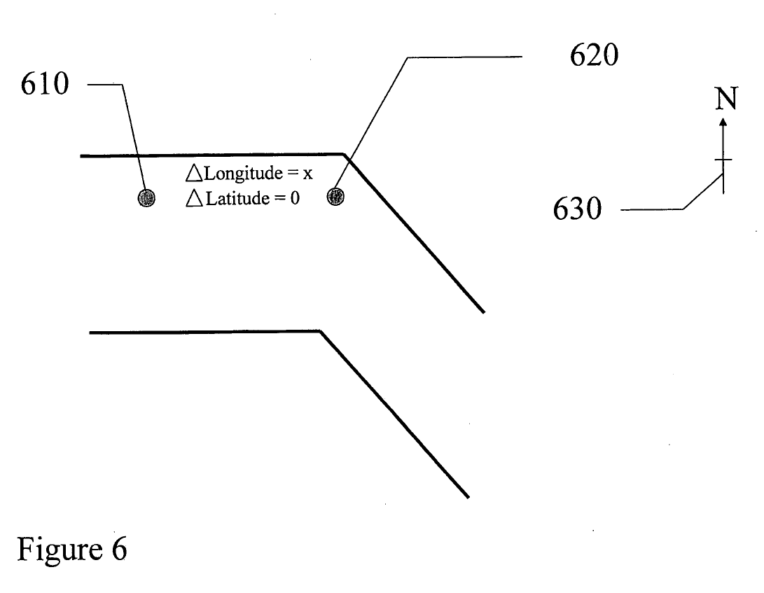

Referring to the sixth sheet of the drawings, FIG. 6 depicts a fifth aspect of the technique using an example path on which an asset moves, location points 610 and 620 are two location points that need to be reported where the latitude does not change but longitude changes by an amount x. For reference an arrow 630 shows the direction of North.

As shown in FIG. 6, when location information at location point 620 is reported, in one embodiment, only x is transmitted as a change in longitude. In one embodiment, optionally 0 is also transmitted as change in latitude in addition to the change in longitude. In one embodiment, although not expressly shown in the drawing, only a change in latitude is transmitted.

Thus, according to a fifth aspect, for reports that are about near points, only the change in information is reported. In alternate embodiments, the change in information includes change in either latitude, or longitude, or both. The latter case being the preferred mode for this aspect envisaged by the inventors. In one embodiment, on the occurrence of an event, the full information values are reported as opposed to only the change in information. In one embodiment, the change in information includes changes to other reported fields, such as for example timestamps. In one embodiment, there are custom application fields. In one embodiment, the custom application fields and messages that are reported are selected from those defined in the NMEA structure (for e.g. any field or message such as altitude defined at http://home.mira.net/˜gnb/gps/nmea.html or at http://www.nmea.org/pub/0183/). Depending on the application requirement these fields may be required, as would be obvious to a person of skill in the art in view of the present application.

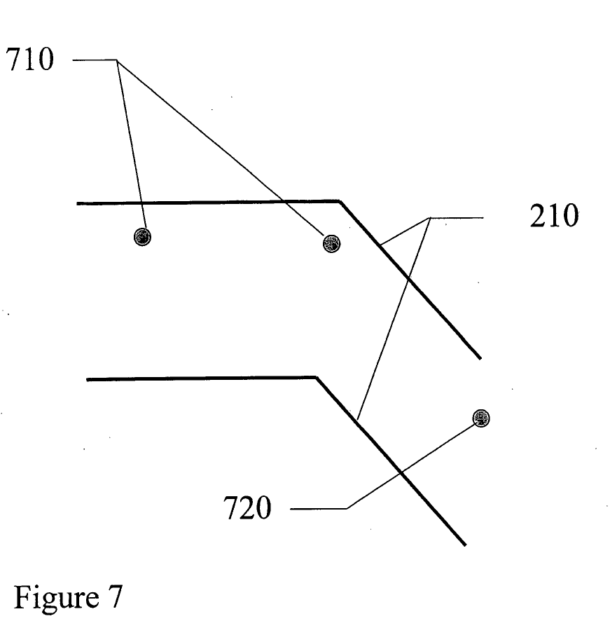

Referring to the seventh sheet of the drawings, FIG. 7 depicts a sixth aspect of the technique using an example path on which an asset moves, location points 710 are collected by reporting system 120 but not reported at that time, whereas when location point 720 is reported so are location points 710 and 720 reported.

This would for example happen when radio coverage of the radio channel 130 is not available, such as at times when location point 710 is obtained but reporting system 120 is back in coverage by the time 720 is obtained. At that time all locations are reported.

Thus, according to a sixth aspect, it is possible that the device which reports location might be in a pre-determined condition for a period of time, and in such a situation, during the pre-determined condition, the device can collect information to report, but not report it until the pre-determined condition is removed. In one embodiment, the pre-determined condition is an out of data coverage condition. In one embodiment, the information that the device collects includes points. In one embodiment, the information that the device collects includes time stamps in addition to collecting points. In one embodiment, the device reports the information collected once the pre-determined condition has been removed. The latter being a preferred mode envisaged for this aspect of the application by the inventors. In one embodiment, the pre-determined condition need not be an out of data coverage condition, whereby non-real-time reporting is enabled. Other pre-determined conditions contemplated include time of day (e.g. no reports needed at night, or in the alternative collecting all day and reporting at off peak hours, or further alternatively just accumulating data and sending in a burst, when for example being timely is not very critical, but data is sent in bursts to make the most use of payloads.

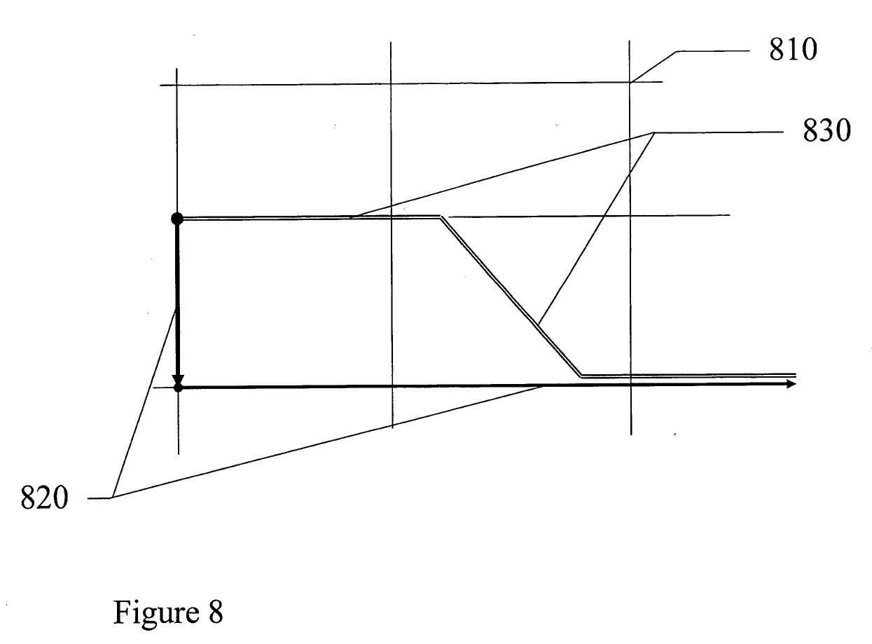

Referring to the eighth sheet of the drawings, FIG. 8 depicts a seventh aspect of the technique using an example path on which an asset moves, an asset is traversing a network of paths 810. The path taken by asset or route 820 is shown, while an alternative path or route 830 that the asset occasionally takes is also shown.

As shown in FIG. 8, a unique identifier for route 820 can be transmitted which represents the entire path traversed. Alternatively, on another occasion, when the asset might travel on alternate route 830 the identification for that route is reported, instead of reporting all intermediate points.

Thus, according to a seventh aspect, upon the condition that the assets traverse specific routes routinely, the routes can be recorded and indexed. In one embodiment, only the route numbers are reported. In one embodiment, points on route are identified by scaling the route and reporting the timestamp when each fractions of the route is covered. In one embodiment, the reporting of points on route is only performed if timestamps of intermediate points are a requirement.

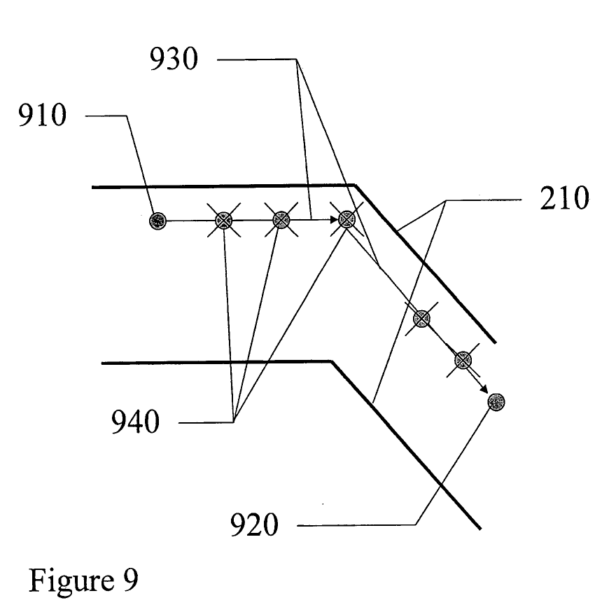

Referring to the drawings, FIG. 9 depicts an eighth aspect of the technique using an example path on which an asset moves, first location point 910 represents a first location whereat location information is reported on a given path 210. Location point 920 is the next location that location information is reported. Path 930 is the path that can be uniquely mapped within 210 when it is known that the asset will not cross the path's 210 boundary. Location points 940 represent example points that are advantageously not reported.

FIG. 9 also shows that reporting system 120 decides to only report locations 910 and 920, since the asset is staying on path 210 and other unreported points can be interpolated to be on path 930, even though they are not in a straight line.

Thus, according to an eighth aspect, if map data is known to the mobile, and the asset is known to be always on a feature of a map, the mobile can use that information to determine when to report points. In one embodiment, the feature is streets. In one embodiment, if the mobile is on a given street which may not be straight, the mobile only reports the end points while the asset is on the street, since the not straight street can be deterministically recreated on the server side. In one embodiment, in addition to reporting end points, some intermediate points are reported as well.

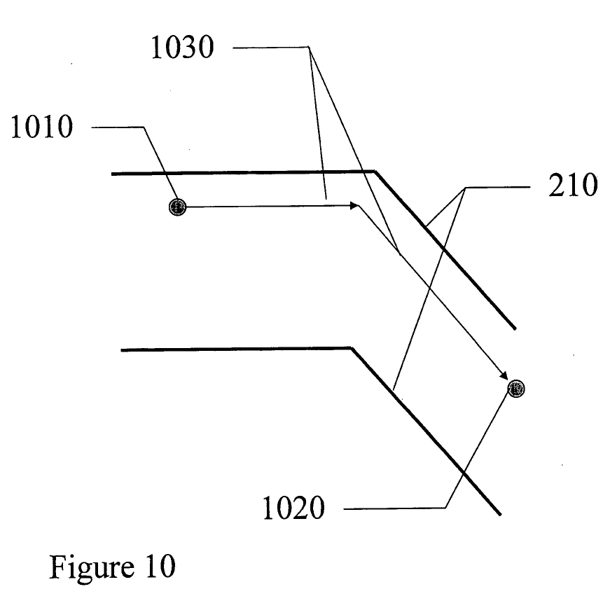

Referring to the tenth sheet of the drawings, FIG. 10 depicts a ninth aspect of the technique using an example path on which an asset moves, shows two locations 1010 and 1020 whereat location information is reported to server 160. Paths 1030 represent the server interpolating the path traversed by the asset.

In FIG. 10, the server 1030 is able to reconstruct the path 1030 just using 1010 and 1020, since it can uniquely do so if the asset is known to stay on 210.

Thus, according to an ninth aspect, when the asset is known to be always on streets, a server can “smoothen” a curve by joining the reported points and constraining them to be on the streets (using its map data) rather than just joining the points directly.

According to a tenth aspect, all of the above aspects can be used on their own or in combination in embodiments of an apparatus and methods suitable for location related information reporting. In one embodiment, a message is sent to the server, indicating what aspects are being used, so the server can appropriately make use of the reported information. Those ordinarily skilled in the art will know to use appropriate combinations and thresholds on the first nine aspects to produce appropriate results in view of the present application.

The above-described embodiments of the present application are intended to be examples only. Those of skill in the art may effect alterations, modifications and variations to the particular embodiments without departing from the scope of the application, which is set forth in the claims.

What is claimed is:

1. A method suitable for location reporting, comprising the step of reporting location information periodically based on a distance period.

2. The method as recited in claim 1, further comprising the step of determining that a new point is at least the distance period away from a previous point as a pre-condition to the step of reporting location information.

3. The method as recited in claim 1, further comprising the step of providing a location report.

4. The method as recited in claim 1, wherein the location information includes information about an asset.

5. The method as recited in claim 4, further comprising the step of assuming that an asset is at a same location if a new location point for the asset is not at least a distance period away from a previous location point.

6. The method as recited in claim 5, further comprising the step of not sending a location report if the asset can be assumed to be at the same location.

7. The method as recited in claim 1, wherein the distance period is a given pre-determined value.

8. The method as recited in claim 1, wherein the distance period is a configurable value.

9. The method as recited in claim 1, further comprising the step of using a configurable parameter for reporting no later than a period when actively reporting.

10. The method as recited in claim 3, further comprising the step of determining a direction for the moving asset from information in the location report.

11. The method as recited in claim 10, wherein the information used to determine the direction of the moving asset is obtained directly from the location report.

12. The method as recited in claim 10, wherein the information used to determine the direction of the moving asset is obtained indirectly by using a previous point.

13. The method as recited in claim 10, wherein the information used to determine the direction of the moving asset is obtained using velocity information.

14. The method as recited in claim 10, further comprising the step of reporting direction when there is a change in direction by at least a direction change threshold value.

15. The method as recited in claim 14, wherein the direction change threshold value is a pre-determined value.

16. The method as recited in claim 15, wherein the direction change threshold value is a configurable value.

17. The method as recited in claim 15, further comprising the step of using a configurable parameter for reporting no later than a period when actively reporting.

18. The method as recited in claim 1, further comprising the step of recording a plurality of points traversed.

19. The method as recited in claim 18, further comprising the step of periodically going through the plurality of points traversed to report on at least one critical point selected from the plurality of points traversed.

20. The method as recited in claim 19, further comprising the step of determining the at least one critical point can be determined by an optimum number of points that can be used to reconstruct the path within an error.

21. The method as recited in claim 20, wherein the error is a pre-determined value.

22. The method as recited in claim 20, wherein the error is a configurable value.

23. The method as recited in claim 22, further comprising the step of basing the configurable error value on how timely the report needs to be.

24. The method as recited in claim 20, wherein small delays in reporting are an indication of acceptable error.

25. The method as recited in claim 19, further comprising the step of creating at least one new critical point by interpolating between two points selected from the plurality of recorded points.

26. The method as recited in claim 19, further comprising the step of creating at least one new critical point by extrapolating using points selected from the plurality of recorded points.

27. The method as recited in claim 25 or 26, further comprising the step of fitting a curve based on the at least one new critical point.

28. The method as recited in claim 1, wherein the location information includes information about near points.

29. The method as recited in claim 1, further comprising the step of reporting a change in location information.

30. The method as recited in claim 29, wherein only a change in location information is provided for location information about near points.

31. The method as recited in claim 29, wherein the change in location information includes change in latitude.

32. The method as recited in claim 29, wherein the change in location information includes change in longitude.

33. The method as recited in claim 29, wherein the change in location information includes change in longitude and latitude.

34. The method as recited in claim 29, further comprising the step of reporting the location information on occurrence of an event.

35. The method as recited in claim 34, wherein the even occurs occasionally suitable to fix any potential errors.

36. The method as recited in claim 29, wherein the change in information includes changes to a reported field.

37. The method as recited in claim 36, wherein the reported field is a timestamp.

38. The method as recited in claim 36, wherein the reported information is information derived from an NMEA structure.

39. The method as recited in claim 1, further comprising the step of determining that a device which reports location is in a pre-determined condition for a period of time.

40. The method as recited in claim 39, further comprising the step of, during the pre-determined condition, collecting information to report.

41. The method as recited in claim 39, further comprising the step of not reporting the collected information until the pre-determined condition is removed.

42. The method as recited in clam 39, wherein the pre-determined condition is an out of data coverage condition.

43. The method as recited in claim 39, wherein the information that the device collects includes points.

44. The method as recited in claim 39, wherein the information that the device collects includes time stamps.

45. The method as recited in claim 39, further comprising the step of reporting the information collected once the pre-determined condition has been removed.

46. The method as recited in claim 39, wherein the pre-determined condition includes a condition which is not an out of data coverage condition, whereby non-real-time reporting is enabled.

47. The method as recited in claim 39, wherein the pre-determined condition includes a condition representative of the time of day.

48. The method as recited in claim 39, wherein the pre-determined condition includes a condition representative of the off-peak hours for data usage.

49. The method as recited in claim 4, further comprising the step of determining a condition that the asset traverses a specific route routinely.

50. The method as recited in claim 49, wherein the specific route is recorded and indexed using route numbers.

51. The method as recited in claim 50, further comprising the step of reporting a route number.

52. The method as recited in claim 51, wherein only the route number is reported.

53. The method as recited in claim 52, further comprising the step of identifying points on the route.

54. The method as recited in claim 53, wherein the step of identifying points on the route comprises the act of scaling the route and reporting the timestamp when a fraction of the route is covered.

55. The method as recited in claim 54, wherein the step of reporting points on route is only performed if timestamps of intermediate points are a requirement.

56. The method as recited in claim 4, further comprising the step of providing map data at a mobile device used to track an asset.

57. The method as recited in claim 56, further comprising the step of determining that and the asset is known to be always on a feature of a map.

58. The method as recited in claim 57, further comprising the step of using the map data at the mobile device to determine when to report points.

59. The method as recited in claim 57, wherein the feature is streets.

60. The method as recited in claim 57, wherein the feature is water.

61. The method as recited in claim 57, further comprising the step of determining if the mobile device is on a given feature which may not be straight.

62. The method as recited in claim 57, further comprising the step of reporting the end points of the feature while the asset is on the feature.

63. The method as recited in claim 57, further comprising the step of deterministically recreating the feature on a server using the end points.

64. The method as recited in claim 57, further comprising the step of reporting intermediate points.

65. [Ninth aspect] The method as recited in claim 57, further comprising the step smoothening a curve for the feature by joining reported points and constraining them to be on the streets.

66. The method as recited in claim 57, wherein a server accomplishes the smoothening step using map data provided at the server.

67. A method as recited according to claims 1-66, wherein the method steps are used on their own or in combination.

68. The method as recited according to claim 67, further comprising the step of sending a message from a mobile device to a server indicating which steps are being used, so that the server can appropriately make use of the reported information.

69. An apparatus suitable for location reporting, the apparatus comprising means for accomplishing the steps of the method as recited according to claims 1-68.

70. The apparatus as recited in claim 69, wherein the means include a mobile device.

71. The apparatus as recited in claim 69, wherein the means include a server device.
